(19) United States
(12) Patent Application Publication
(10) Pub. No.: US 2025/0298700 A1
(43) Pub. Date: Sep. 25, 2025

(54) METHOD, DEVICE, AND COMPUTER PROGRAM PRODUCT FOR BACKUP

(71) Applicant: Dell Products L.P., Round Rock, TX (US)

(72) Inventors: Jie Huang, Chengdu (CN); Guoping Guan, Chengdu (CN); Qiu Zhong, Chengdu (CN)

(21) Appl. No.: 18/897,619

(22) Filed: Sep. 26, 2024

(30) Foreign Application Priority Data
Mar. 21, 2024 (CN) 202410333677.0

(51) Int. Cl. G06F 11/14

(52) U.S. Cl. CPC G06F 11/1464; G06F 11/1461

(57) ABSTRACT

Techniques for backup involve determining parameters of replication sessions in a waiting queue in response to a backup execution command being triggered; and such techniques further involve determining weights of the replication sessions based on the parameters of the replication sessions. Such techniques further involve selecting at least one replication session from the replication sessions to enter a running queue based on the weights of the replication sessions. Such techniques further involve performing a backup task with respect to the at least one replication session in the running queue. Accordingly, each replication session is ranked based on priority, and parameters are taken into account in the ranking to improve backup efficiency, thereby reducing the number of waiting and failed tasks and better protecting data, which enhances the replication capability of the system and increases the replication limit number to prevent the system from running out of memory.

### CROSS-REFERENCE TO RELATED APPLICATION

This application claims priority to Chinese Patent Application No. CN202410333677.0, on file at the China National Intellectual Property Administration (CNIPA), having a filing date of Mar. 21, 2024, and having “METHOD, DEVICE, AND COMPUTER PROGRAM PRODUCT FOR BACKUP” as a title, the contents and teachings of which are herein incorporated by reference in their entirety.

### TECHNICAL FIELD

Embodiments of the present disclosure relate to the field of data management, and more particularly, to a method, a device, and a computer program product for backup.

### BACKGROUND

Data backup is an important measure to protect the security and privacy of data. When the hardware or storage media of a system fails, backup tools can be used to protect data from accidental loss. During data backup, for example, the recovery point objective (RPO) is an important indicator in measuring the level of disaster recovery capability. RPO is the requirement for the point in time to which the system and data must be restored after a disaster, and represents the maximum amount of data loss that a facility can tolerate.

In the case where there are a large number of backup tasks waiting to be executed on the same system, some of the tasks will be executed first in the running queue, while some of the backup tasks are waiting to be executed in the waiting queue. Typically, a first-in-first-out (FIFO) policy is used for backups, where the FIFO memory is a first-in-first-out double-port buffer, i.e., the first piece of data that enters it is moved first, i.e., the backup task that enters the waiting queue first is also first to be selected to enter the running queue.

### SUMMARY OF THE INVENTION

Embodiments of the present disclosure provide a method, a device, and a computer program product for backup.

In a first aspect of embodiments of the present disclosure, a method for backup is provided. The method includes determining a plurality of parameters of a plurality of replication sessions in a waiting queue in response to a backup execution command being triggered; and the method further includes determining a plurality of weights of the plurality of replication sessions based on the plurality of parameters of the plurality of replication sessions. The method further includes selecting at least one replication session from the plurality of replication sessions to enter a running queue based on the plurality of weights of the plurality of replication sessions. The method further includes performing a backup task with respect to the at least one replication session in the running queue.

In a second aspect of the embodiments of the present disclosure, an electronic device is provided. The electronic device includes one or more processors; and a storage apparatus for storing one or more programs, where the one or more programs, when executed by the one or more processors, cause the one or more processors to implement a method for backup. The method includes determining a plurality of parameters of a plurality of replication sessions in a waiting queue in response to a backup execution command being triggered; and the method further includes determining a plurality of weights of the plurality of replication sessions based on the plurality of parameters of the plurality of replication sessions. The method further includes selecting at least one replication session from the plurality of replication sessions to enter a running queue based on the plurality of weights of the plurality of replication sessions. The method further includes performing a backup task with respect to the at least one replication session in the running queue.

In a third aspect of embodiments of the present disclosure, a computer-readable storage medium is provided on which a computer program is stored, wherein the program, when executed by a processor, implements a method for backup. The method includes determining a plurality of parameters of a plurality of replication sessions in a waiting queue in response to a backup execution command being triggered; and the method further includes determining a plurality of weights of the plurality of replication sessions based on the plurality of parameters of the plurality of replication sessions. The method further includes selecting at least one replication session from the plurality of replication sessions to enter a running queue based on the plurality of weights of the plurality of replication sessions. The method further includes performing a backup task with respect to the at least one replication session in the running queue.

It should be understood that the content described in the section of Summary of the Invention is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of embodiments of the present disclosure will become more apparent in conjunction with the accompanying drawings and with reference to the following detailed description. In the accompanying drawings, identical or similar reference numerals represent identical or similar elements, in which:

FIG. 1 illustrates a schematic diagram of an example environment in which a plurality of embodiments of the present disclosure can be implemented;

FIG. 2 illustrates a flow chart of a method for backup according to some embodiments of the present disclosure;

FIG. 3 illustrates a flow chart of a process from the start of a backup to the completion of the backup according to some embodiments of the present disclosure;

FIG. 4 illustrates a schematic diagram of a process of ranking replication sessions in a waiting queue in order of weights according to some embodiments of the present disclosure;

FIG. 5 illustrates a schematic diagram of a process of selecting a replication session from a waiting queue to enter a running queue according to some embodiments of the present disclosure; and

FIG. 6 illustrates a block diagram of a device that can implement a plurality of embodiments of the present disclosure.

In all the accompanying drawings, identical or similar reference numerals indicate identical or similar elements.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second” and the like may refer to different or identical objects, unless explicitly illustrated. Other explicit and implicit definitions may also be included below.

When there is a failure of hardware or storage media of a system, there are typically a large number of backup tasks on the same system. However, the system cannot execute these backup tasks at the same time, which results in that some backup tasks need to queue up in a waiting queue to be executed. Typically, the backup queuing policy uses the FIFO approach, where replication sessions are ranked in order of their arrival time at the waiting queue, and when there is a vacancy in the running queue, the replication session that arrives at the waiting queue first is selected first to enter the running queue for execution of the backup task.

The FIFO approach often results in many queuing tasks, and over time, this causes several problems. First, if the processing time for the replication session that arrives first at the waiting queue is long, the time for which the replication session arriving later waits to be executed is then lengthened, which results in that the later-arriving replication session misses one or more RPOs, leading to a persistent lag in data. Replication sessions missing RPOs will increase data inconsistency between the source end and the remote end and increase the risk of data loss.

Second, many tasks with long running times run concurrently, and the long-term consumption of resources does not allow more tasks with short running times to enter the running state, which reduces the replication capacity of the system, prevents the system from supporting short RPOs, and limits the current replication limit number. Finally, more and more tasks queue up over time, and the system becomes increasingly slow, which not only leads to the system running out of memory (OOM), but also degrades the customer experience.

To this end, embodiments of the present disclosure provide a solution for backup. This solution is to determine a plurality of parameters of a plurality of replication sessions in a waiting queue, determine weights of the plurality of replication sessions according to the plurality of parameters, and select one or more replication sessions from the waiting queue to enter a running queue according to the weights of the replication sessions. In this way, each replication session is ranked based on priority, and a plurality of parameters are taken into account in the ranking to improve the backup efficiency. This reduces the number of queuing backup tasks and the number of failures and improves the running capability of the system. It can also reduce the number of RPOs missed by backup tasks, provide better protection for data, and enhance the replication capability of the system, so as to support shorter RPOs and increase the replication limit number to prevent the system from running out of memory.

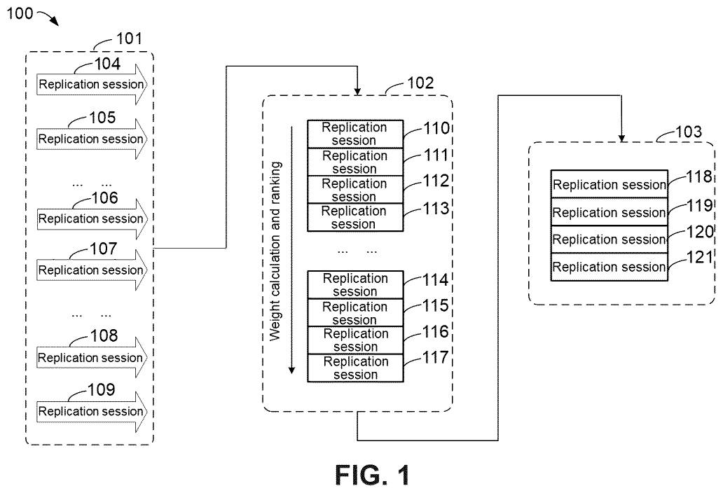

FIG. 1 illustrates a schematic diagram of an example environment 100 in which a plurality of embodiments of the present disclosure can be implemented. As shown in FIG. 1, the example environment 100 may include a backup task 101, and the backup task 101 may include a replication session 104, a replication session 105, a replication session 106, a replication session 107, a replication session 108, and a replication session 109 as well as other replication sessions, and during specific implementations, the number of replication sessions in the backup task 101 and the generation time are determined by the data that needs to be backed up at the time of the disaster. In some embodiments, the replication session 104 to the replication session 109 may be replication sessions generated in chronological order. For example, the replication session 104 is the earliest generated session, and the replication session 109 is the latest generated session.

In some embodiments, the example environment 100 may further include a waiting queue 102. The replication sessions in the backup task 101 may arrive at the waiting queue 102 in chronological order, and after the replication sessions enter the waiting queue 102, a plurality of parameters of a plurality of replication sessions in the waiting queue may be determined. The parameters may include, but are not limited to, an arrival time, an expected processing time, and a turnaround time of a replication session, a running queue length, and the like, and the type and number of the parameters may be selected based on the actual need. Any data that has an impact on the backup result during the backup process can be selected as a parameter, specifically depending on the purpose of supporting short RPOs and improving the backup capability of the system.

According to embodiments of the present disclosure, after determining the plurality of parameters of the plurality of replication sessions in the waiting queue 102, weights of the plurality of replication sessions may be calculated according to the determined plurality of parameters, wherein the weight of each replication session may be obtained through calculation based on a single parameter or a combination of a plurality of parameters, the calculation method can be any algorithm determined according to parameters, and the scope of the present disclosure is not limited in this respect. After determining the weight of each replication session, the replication sessions may be ranked according to their weights. For example, as shown in FIG. 1, the weights of the replication session 110, the replication session 111, the replication session 112, the replication session 113, the replication session 114, the replication session 115, the replication session 116, and the replication session 117 become larger in sequence, or they may become smaller in sequence.

Referring to FIG. 1, the example environment 100 may further include a running queue 103. After a weight is determined for each replication session in the waiting sequence 102, a replication session may be selected from the waiting queue 102 to enter the running queue 103 in accordance with the weights. For example, the replication session 118, the replication session 119, the replication session 120, and other replication sessions 121 with the largest or smallest weight may be selected to enter the running queue 103, and the backup task may be performed based on the replication sessions in the running queue 103.

As can be seen from the above description, the solution of the present disclosure is to determine a plurality of parameters of a plurality of replication sessions in a waiting queue, determine weights of the plurality of replication sessions according to the plurality of parameters, and select, according to the weights of the replication sessions, one or more replication sessions from the waiting queue to enter a running queue. This approach can improve the backup efficiency, reduce the risk of the system being in a huge queue, and avoid the problem of running out of system resources, and can also reduce the number of RPOs missed by the backup task, provide better protection for disaster recovery data, and enhance the replication capability of the system, so as to support shorter RPOs and increase the replication limit number.

It should be understood that description of the architecture and function in the example environment 100 is made for illustrative purposes only and does not imply any limitation to the scope of the present disclosure. The embodiments of the present disclosure may also be applied to other environments having different structures and/or functions.

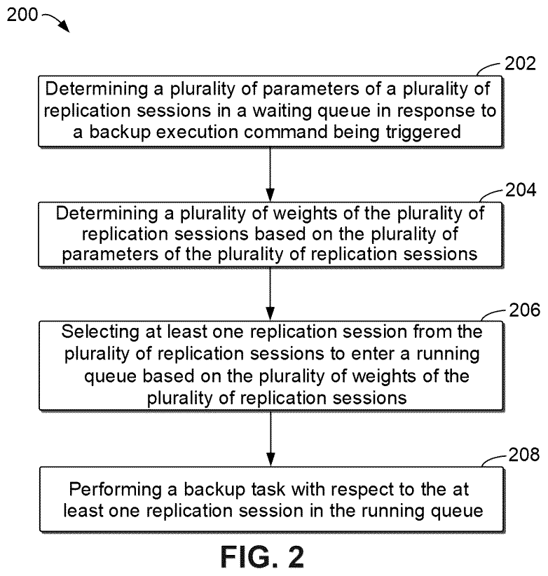

The processes according to embodiments of the present disclosure will be described in detail below with reference to FIGS. 2 to 6. For case of understanding, the specific data mentioned in the following description are all illustrative and are not intended to limit the scope of protection of the present disclosure. It should be understood that the embodiments described below may also include additional actions not shown and/or may omit actions shown, and the scope of the present disclosure is not limited in this regard.

FIG. 2 illustrates a flow chart of a method 200 for backup according to some embodiments of the present disclosure. At block 202, a plurality of parameters of a plurality of replication sessions in a waiting queue are determined in response to a backup execution command being triggered. For example, as shown in FIG. 1, upon arrival of the replication sessions in the backup task 101 at the waiting queue 102, the backup execution command is triggered, and the system begins to synchronize the replication sessions between the source end and the remote end, wherein the process of synchronization includes determining a plurality of parameters of the plurality of replication sessions in the waiting queue 102. The type and number of the parameters may be selected based on the actual need. Any data that has an impact on the backup result during the backup process can be selected as a parameter, specifically depending on the purpose of supporting short RPOs and improving the backup capability of the system.

At block 204, a plurality of weights of the plurality of replication sessions are determined based on the plurality of parameters of the plurality of replication sessions. For example, as shown in FIG. 1, after determining a plurality of parameters of each replication session, a weight of each replication session in the waiting queue 102 is determined according to the plurality of parameters. The weight of each replication session may be obtained through calculation based on a single parameter or a combination of a plurality of parameters, the calculation method can be any algorithm determined according to parameters, and the scope of the present disclosure is not limited in this respect.

At block 206, at least one replication session is selected from the plurality of replication sessions to enter a running queue based on the plurality of weights of the plurality of replication sessions. For example, as shown in FIG. 1, the replication sessions may be ranked in ascending order of their weights, where the replication session 117 has a greater weight than that of the replication session 116, so when there is a vacancy in the running queue 103, the replication session 117 will enter the running queue 103 first than the replication session 116, and the backup command for the replication session 117 will be executed first. In this way, each replication session is ranked based on priority, and a plurality of types of parameters are taken into account in the ranking to improve the execution efficiency, thereby reducing the number of waiting tasks and ensuring that the risk of missing RPOs is reduced.

At block 208, a backup task is performed with respect to the at least one replication session in the running queue. For example, as shown in FIG. 1, the backup task may be performed simultaneously for the replication session 118, the replication session 119, the replication session 120, and other replication sessions 121 in the running queue 103, or the backup task may be performed for any one or more replication sessions in the running queue 103. This can specifically be selected based on the actual need, and the scope of the present disclosure is not limited in this respect.

This approach can improve the backup efficiency, reduce the risk of the system being in a huge queue, and avoid the problem of running out of system resources, and can also reduce the number of RPOs missed by the backup task, provide better protection for disaster recovery data, and enhance the replication capability of the system, so as to support shorter RPOs and increase the replication limit number.

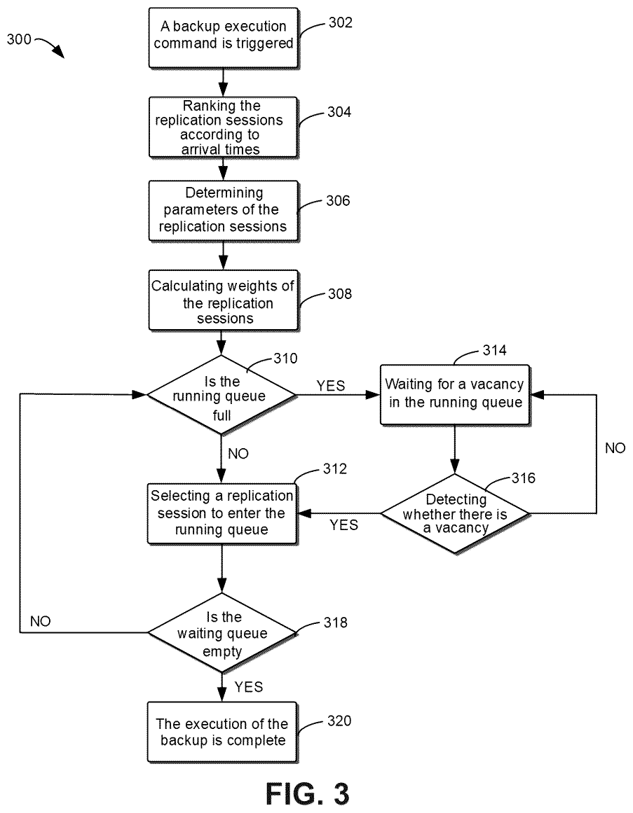

The process of backup execution is described in detail below in connection with FIGS. 3 through 6. The specific data mentioned in the following description are illustrative and are not intended to limit the scope of protection of the present disclosure. It should be understood that the embodiments described below may also include additional actions not shown and/or may omit actions shown, and the scope of the present disclosure is not limited in this regard.

FIG. 3 illustrates a schematic diagram of a process 300 from the start of a backup to the completion of the backup according to some embodiments of the present disclosure. At block 302, a backup execution command is triggered. For example, as shown in FIG. 1, the backup execution command is triggered when the replication sessions in the backup task 101 arrive at the waiting queue 102. At block 304, the replication sessions are ranked according to arrival times. For example, as shown in FIG. 1, the replication sessions may first be ranked by the arrival time, and the replication session 112 arrives at the waiting queue 102 earlier than the replication session 113, then the replication session 112 may be ranked before the replication session 113.

At block 306, parameters of the replication sessions are determined. The parameters of each replication session can be determined sequentially in the ranking order to reduce omissions. The type and number of the parameters of the replication sessions may be selected based on the actual need. Any data that has an impact on the backup result during the backup process can be selected as a parameter, specifically depending on the purpose of supporting short RPOs and improving the backup capability of the system.

In some embodiments, the plurality of parameters may include a waiting time (WT) of each replication session in the waiting queue, a predicted execution time (PT) of each replication session, a data recovery point objective level (RPO) of each replication session, a user-defined level (UP) of each replication session, a running queue length (QL), an arrival time (AT) of each replication session at the waiting queue, and a execution start time (ST) of the arrival of each replication session at the running queue, where the waiting time (WT) may be expressed as:

$$WT = ST - AT \qquad ( 1 )$$

The plurality of parameters may further include a turnaround time (TT) and a weighted turnaround time (WTT), where the turnaround time (TT) may be expressed as:

$$TT = ST + AT - PT \qquad ( 2 )$$

The weighted turnaround time (WTT) may be expressed as:

$$WTT = TT / PT \qquad ( 3 )$$

At block 308, weights of the replication sessions are calculated. A weight of each replication session may be calculated according to the determined plurality of parameters, the calculation method can be an algorithm determined according to parameters, and the scope of the present disclosure is not limited in this respect.

In some embodiments, for the weights of the replication sessions, the weight of each replication session may be determined based on the waiting time (WT) of each replication session in the waiting queue and the predicted execution time (PT) of each replication session, where the weight of the replication session may be expressed as:

$$S W = ( WT + PT ) / PT \qquad ( 4 )$$

The waiting time (WT) of each replication session in the waiting queue is used as the denominator, indicating that the longer the waiting time (WT), the greater the weight SW of the replication session; however, when the waiting time (WT) is the same, the shorter the predicted execution time (PT) of each replication session, the greater the weight SW of the replication session.

In some embodiments, for the weights of the replication sessions, the weight of each replication session may be determined based on the waiting time (WT) of each replication session in the waiting queue, the predicted execution time (PT) of each replication session, and the data recovery point objective level (RPO) of each replication session, where the weight of the replication session may be expressed as:

$$SW = ( WT + PT ) / PT ⋆ ( WT / RPO ) \qquad ( 5 )$$

It can be seen from Equation (5) that the shorter the data recovery point objective level (RPO) of each replication session, the greater the weight SW of the replication session.

In some embodiments, for the weights of the replication sessions, the weight of each replication session may be determined based on the waiting time (WT) of each replication session in the waiting queue, the predicted execution time (PT) of each replication session, the data recovery point objective level (RPO), and the user-defined level (UP) of each replication session, where the weight of the replication session may be expressed as:

$$S W = ( WT + PT ) / PT ⋆ ( WT / RPO ) ⋆ UP \qquad ( 6 )$$

In a case where all parameters of two replication sessions are the same, the user can choose the replication session that enters the running queue first by customizing the level of the replication session.

At block 310, it is determined whether the running queue is full. Typically, there are a limited number of sessions that can run concurrently in the running queue, and a new replication session can only be added to the running queue when there is a vacancy in the running queue. For example, the maximum number of concurrent running sessions in the running queue is 500, and if there are 400 backup tasks being executed, the number of vacancies in the running queue is 100; if there are 500 backup tasks being executed, the running queue is full.

At block 312, a replication session is selected to enter the running queue. When a vacancy exists in the running queue, at least one replication session in the waiting queue may be selected according to its weight to enter the running queue. For example, as shown in FIG. 1, the replication sessions may be ranked in ascending order of their weights, where replication session 117 has a greater weight than that of replication session 116, so when there is a vacancy in the running queue 103, replication session 117 will enter the running queue 103 before replication session 116, and the backup command for replication session 117 will be executed first.

At block 314, a vacancy in the running queue is awaited. When the running queue is full, the maximum number of concurrently running sessions is reached, and it is necessary to wait for some backup tasks to be completed first. At block 316, it is detected whether there is a vacancy. After some of or all the backup tasks in the running queue have been executed, the running queue is in a not-full state, which indicates that there are vacancies in the running queue. Then, at least one replication session can be selected from the plurality of replication sessions to enter the running queue. When there is no vacancy detected in the running queue,

At block 318, it is determined whether the waiting queue is empty. After selecting a replication session to enter the running queue, if there are no remaining replication sessions in the waiting queue waiting to run, i.e., the waiting queue is an empty queue, the process proceeds to block 320, i.e., the execution of the backup task has been completed. It is determined that the backup task has been completed in response to the waiting queue being an empty queue.

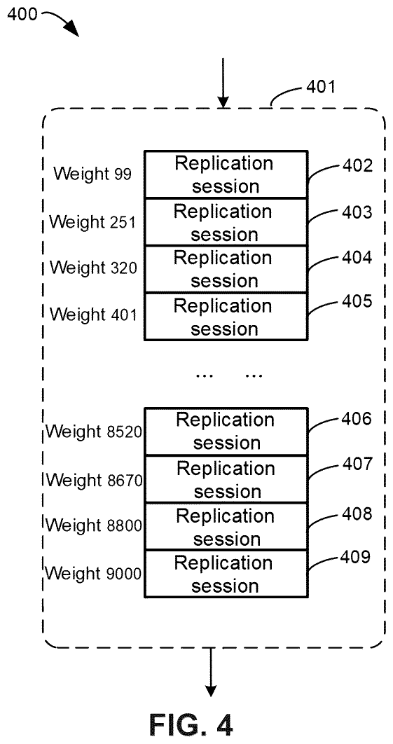

FIG. 4 illustrates a schematic diagram of a process 400 of ranking replication sessions in a waiting queue in order of weights according to some embodiments of the present disclosure. In the waiting queue 401, the weights of the plurality of replication sessions may be calculated according to the determined plurality of parameters, and the replication sessions may be ranked according to their weights. In some embodiments, the weight of each replication session in the waiting queue 401 may be calculated in accordance with any of Equation (4), Equation (5), or Equation (6), and the replication sessions may be ranked in ascending order. For example, the weights of replication session 402, replication session 403, replication session 404, replication session 405, replication session 406, replication session 407, replication session 408, the replication session 409 are sequentially larger.

In some embodiments, a replication session with a greater weight in the waiting queue may be selected to enter the running queue. For example, replication session 409 is the replication session with the largest weight in the current waiting queue 401 as calculated in accordance with Equation (6). Therefore, when there is a vacancy in the running queue, replication session 409 enters the running queue with a higher priority than the other replication sessions.

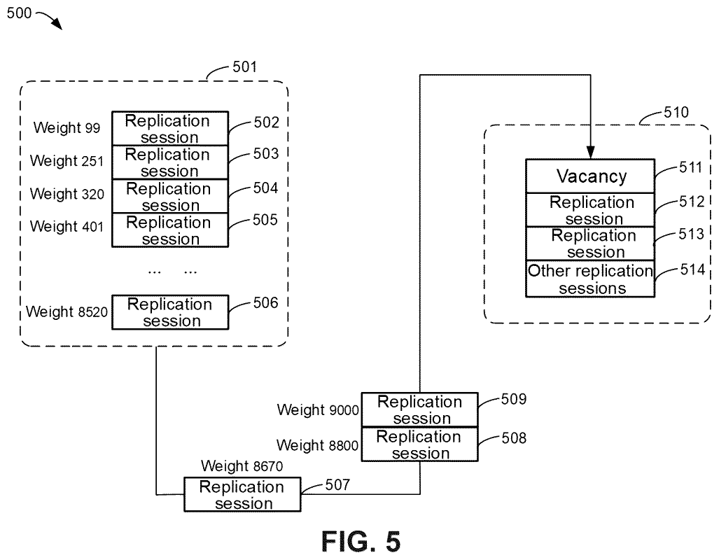

FIG. 5 illustrates a schematic diagram of a process 500 of selecting a replication session from a waiting queue to enter a running queue according to some embodiments of the present disclosure. In the waiting queue 501, the weights of the plurality of replication sessions may be calculated according to the determined plurality of parameters, and the replication sessions may be ranked according to their weights. In some embodiments, the weight of each replication session in the waiting queue 501 may be calculated in accordance with any of Equation (4), Equation (5), or Equation (6). The weights of replication session 502, replication session 503, replication session 504, replication session 505, replication session 506, replication session 507, replication session 508, and replication session 509 become sequentially larger.

In some embodiments, in response to the running queue not being full, the number of vacancies in the running queue 510 is determined, and the replication sessions in the waiting queue 501 are ranked in ascending order of weights. Then, the replication sessions ranked lower are selected to enter the running queue 510 in a quantity equal to the number of vacancies. For example, if replication session 512, replication session 513, and other replication sessions 514 are being executed in the running queue 510 and the number of vacancies 511 is 3, three replication sessions with greater weights in the waiting queue 501 are preferentially selected to enter the running queue 510 for performance of the backup task. In this way, each replication session is ranked based on priority, and the waiting time (WT), the predicted execution time (PT), the data recovery point objective level (RPO), and the user-defined level (UP) are taken into account in the ranking to improve execution efficiency, thereby reducing the number of waiting tasks and ensuring that the risk of missing RPOs is reduced, which provides better protection for disaster recovery data, enhances the replication capability of the system, and reduces the problem of running out of system resources.

In some embodiments, the present disclosure simulates various RPOs with 1000 sessions and compares the FIFO policy with the backup method of the present disclosure. When the backup method of the present disclosure is used, the replication session waiting time (WT) is significantly reduced by about 15%, the replication session turnaround time (TT) is reduced by about 10%, and the replication session weighted turnaround time (WTT) is significantly reduced by more than 40% to 70%. The above data indicates that, compared with the FIFO policy, the backup method of the present disclosure has a higher backup efficiency, supports shorter RPOs, and can reduce the possibility of data loss.

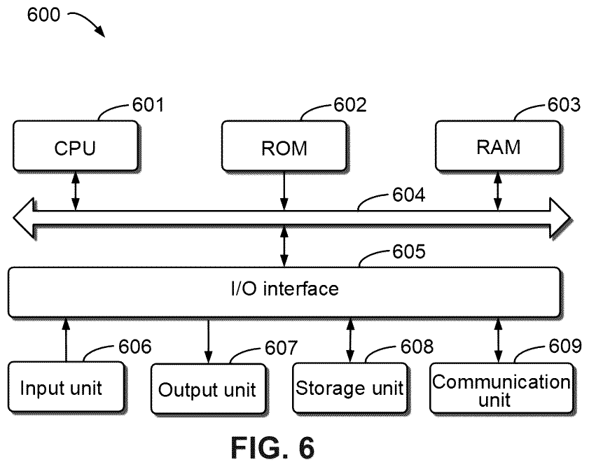

FIG. 6 illustrates a schematic block diagram of an example device 600 that can be used to implement embodiments of the present disclosure. As shown in the figure, the device 600 includes a computing unit 601 that can perform various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The computing unit 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard, a mouse, and the like; an output unit 607, such as various types of displays, speakers, and the like; a storage unit 608, such as a magnetic disk, a compact disc, and the like; and a communication unit 609, such as a network card, a modem, a wireless communication transceiver, and the like. The communication unit 609 allows the device 600 to exchange information/data with other devices via a computer network, such as the Internet and/or various telecommunication networks.

The computing unit 601 may be various general-purpose and/or special-purpose processing components with processing and computing power. Some examples of the computing unit 601 include, but are not limited to, a central processing unit (CPU), a graphics processing unit (GPU), various specialized artificial intelligence (AI) computing chips, various computing units for running machine learning model algorithms, a digital signal processor (DSP), and any appropriate processor, controller, microcontroller, and the like. The computing unit 601 performs the various methods and processes described above, such as the method 200. For example, in some embodiments, the method 200 may be implemented as a computer software program that is tangibly included in a machine-readable medium, such as the storage unit 608. In some embodiments, part of or all the computer program may be loaded and/or installed onto the device 600 via the ROM 602 and/or the communication unit 609. When the computer program is loaded to the RAM 603 and executed by the computing unit 601, one or more steps of the method 200 described above may be performed. Alternatively, in other embodiments, the computing unit 601 may be configured to implement the method 200 in any other suitable manner (such as by means of firmware).

The functions described herein may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Complex Programmable Logic Device (CPLD), and the like.

Program codes for implementing the method of the present disclosure may be written by using one programming language or any combination of a plurality of programming languages. The program code may be provided to a processor or controller of a general-purpose computer, a special-purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve the desired results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for backup, comprising:
determining a plurality of parameters of a plurality of replication sessions in a waiting queue in response to a backup execution command being triggered;
determining a plurality of weights of the plurality of replication sessions based on the plurality of parameters of the plurality of replication sessions;
selecting at least one replication session from the plurality of replication sessions to enter a running queue based on the plurality of weights of the plurality of replication sessions; and
performing a backup task with respect to the at least one replication session in the running queue.

2. The method according to claim 1, wherein determining a plurality of parameters of a plurality of replication sessions in a waiting queue comprises:
determining a waiting time of each of the plurality of replication sessions in the waiting queue, a predicted execution time of each replication session, a data recovery point objective level of said each replication session, and a user-defined level of said each replication session.

3. The method according to claim 2, wherein determining a plurality of weights of the plurality of replication sessions comprises:
determining a weight of each replication session based on a waiting time of said each replication session in the waiting queue and a predicted execution time of said each replication session.

4. The method according to claim 3, wherein determining a weight of each replication session comprises:
determining a sum of the waiting time and the predicted execution time; and
determining a weight of said each replication session based on a ratio of the sum of the waiting time and the predicted execution time to the predicted execution time.

5. The method according to claim 3, wherein determining a weight of each replication session further comprises:
determining a weight of each replication session based on a waiting time of said each replication session in the waiting queue, a predicted execution time of said each replication session, and a ratio of the predicted execution time of said each replication session to a data recovery point objective level of said each replication session.

6. The method according to claim 5, wherein determining a weight of each replication session further comprises:
determining a weight of each replication session based on a waiting time of said each replication session in the waiting queue, a predicted execution time of said each replication session, a ratio of the predicted execution time of said each replication session to a data recovery point objective level of said each replication session, and a user-defined level of said each replication session.

7. The method according to claim 1, wherein selecting at least one replication session from the plurality of replication sessions to enter a running queue comprises:
detecting whether the running queue is full;
waiting for a vacancy in the running queue in response to the running queue being full; and
selecting at least one replication session from the plurality of replication sessions to enter the running queue in response to the running queue not being full.

8. The method according to claim 7, wherein selecting at least one replication session from the plurality of replication sessions to enter the running queue in response to the running queue not being full comprises:
determining the number of vacancies in the running queue in response to the running queue not being full;
ranking the replication sessions in the waiting queue in ascending order of weights; and
selecting replication sessions ranked lower of which the quantity is the number of vacancies to enter the running queue.

9. The method according to claim 1, further comprising:
detecting whether the waiting queue is an empty queue; and
determining that the backup task is complete in response to the waiting queue being an empty queue.

10. An electronic device, comprising:
at least one processor; and
a memory coupled to the at least one processor and having instructions stored thereon, wherein the instructions, when executed by the at least one processor, cause the electronic device to perform actions comprising:
determining a plurality of parameters of a plurality of replication sessions in a waiting queue in response to a backup execution command being triggered;
determining a plurality of weights of the plurality of replication sessions based on the plurality of parameters of the plurality of replication sessions;
selecting at least one replication session from the plurality of replication sessions to enter a running queue based on the plurality of weights of the plurality of replication sessions; and
performing a backup task with respect to the at least one replication session in the running queue.

11. The device according to claim 10, wherein determining a plurality of parameters of a plurality of replication sessions in a waiting queue comprises:
determining a waiting time of each of the plurality of replication sessions in the waiting queue, a predicted execution time of said each replication session, a data recovery point objective level of said each replication session, and a user-defined level of said each replication session.

12. The device according to claim 11, wherein determining a plurality of weights of the plurality of replication sessions comprises:
determining a weight of each replication session based on a waiting time of said each replication session in the waiting queue and a predicted execution time of said each replication session.

13. The device according to claim 12, wherein determining a weight of each replication session comprises:
determining a sum of the waiting time and the predicted execution time; and
determining a weight of said each replication session based on a ratio of the sum of the waiting time and the predicted execution time to the predicted execution time.

14. The device according to claim 12, wherein determining a weight of each replication session further comprises:
determining a weight of each replication session based on a waiting time of said each replication session in the waiting queue, a predicted execution time of said each replication session, and a ratio of the predicted execution time of said each replication session to a data recovery point objective level of said each replication session.

15. The device according to claim 14, wherein determining a weight of each replication session further comprises:
determining a weight of each replication session based on a waiting time of said each replication session in the waiting queue, a predicted execution time of said each replication session, a ratio of the predicted execution time of said each replication session to a data recovery point objective level of said each replication session, and a user-defined level of said each replication session.

16. The device according to claim 10, wherein selecting at least one replication session from the plurality of replication sessions to enter a running queue comprises:
detecting whether the running queue is full;
waiting for a vacancy in the running queue in response to the running queue being full; and
selecting at least one replication session from the plurality of replication sessions to enter the running queue in response to the running queue not being full.

17. The device according to claim 16, wherein selecting at least one replication session from the plurality of replication sessions to enter the running queue in response to the running queue not being full comprises:
determining the number of vacancies in the running queue in response to the running queue not being full;
ranking the replication sessions in the waiting queue in ascending order of weights; and
selecting replication sessions ranked lower of which the quantity is the number of vacancies to enter the running queue.

18. The device according to claim 10, further comprising:
detecting whether the waiting queue is an empty queue; and
determining that the backup task is complete in response to the waiting queue being an empty queue.

19. A computer program product having a non-transitory computer readable medium which stores a set of instructions to perform backup; the set of instructions, when carried out by computerized circuitry, causing the computerized circuitry to perform a method of:
determining a plurality of parameters of a plurality of replication sessions in a waiting queue in response to a backup execution command being triggered;
determining a plurality of weights of the plurality of replication sessions based on the plurality of parameters of the plurality of replication sessions;
selecting at least one replication session from the plurality of replication sessions to enter a running queue based on the plurality of weights of the plurality of replication sessions; and
performing a backup task with respect to the at least one replication session in the running queue.

20. The computer program product according to claim 19, wherein determining a plurality of parameters of a plurality of replication sessions in a waiting queue comprises:
determining a waiting time of each of the plurality of replication sessions in the waiting queue, a predicted execution time of said each replication session, a data recovery point objective level of said each replication session, and a user-defined level of said each replication session.
